(19) United States
(12) Patent Application Publication
(10) Pub. No.: US 2025/0100858 A1
(43) Pub. Date: Mar. 27, 2025

(54) LIFTING DEVICE FOR A DUNNAGE CONVERSION MACHINE

(71) Applicant: Ranpak Corp., Concord Township, OH (US)

(72) Inventor: Jordy VAN DER KAAP, Schimmert (NL)

(73) Assignee: Ranpak Corp., Concord Township, OH (US)

(21) Appl. No.: 18/834,013

(22) PCT Filed: Jan. 23, 2023
(86) PCT No.: PCT/US2023/061106

§ 371 Date: Jul. 29, 2024

Related U.S. Application Data
(60) Provisional application No. 63/267,162, filed on Jan. 26, 2022.

(51) Int. Cl. B66F 9/18; B31D 5/00; B62B 3/04; B66F 9/22

(52) U.S. Cl. CPC B66F 9/18; B62B 3/04; B66F 9/22; B31D 5/0039; B31D 2205/0076

(57) ABSTRACT

A lifting device (20) for lifting and transporting a dunnage conversion machine (30) to and from an elevated position has a small footprint that allows for better maneuverability in tight spaces difficult for a forklift to access. The lifting device includes a base frame (42), an upright support (44) that is fixed relative to the base frame, and an extendable support (48) that is adjustable between a lower position and a higher position. The lifting device also includes a lifting unit (46) coupled to the extendable support to raise and lower the extendable support relative to the base frame between the lower position and the higher position. The extendable support is configured to be attached to the dunnage conversion machine by a machine interface bracket (60).

### FIELD OF THE INVENTION

This invention is related to the field of packaging, particularly to dunnage conversion machines, and more particularly to devices and methods for transporting dunnage conversion machines to and from packaging assembly lines.

### BACKGROUND

In the process of shipping one or more articles in a container, dunnage products typically are placed in the container to fill voids and to protect the articles during shipment. Such dunnage products can be made of plastic, such as air bags or bubble wrap, or paper, such as a crumpled paper dunnage product.

A dunnage conversion machine converts a sheet stock material into a relatively lower density dunnage product. The sheet stock material typically is provided as a continuous sheet in a compact shape, such as a roll or a fan-fold stack. This enables a dunnage conversion machine to convert the sheet stock material into a substantially continuous, and lower density compared to the sheet stock material, strip of dunnage. The discrete dunnage products then may be separated from the strip and provided to an assembly line packing process.

These dunnage machines generally are too heavy for one person to lift without some type of assistance. Accordingly, a powered forklift is usually used to support the weight and carry the machines to desired locations. Once in place, the conversion machine may be provided with wheels for moving short distances.

### SUMMARY

To maximize space utilization, a packaging assembly line may not have very much room beside and around the assembly line. And dunnage conversion machines may be mounted at an elevated location to provide dunnage products to the packaging assembly line. Packaging lines that use dunnage conversion machines mounted at an elevated location often use forklifts to deliver and support the conversion machines while being mounted. But forklifts are large machines that don't have great maneuverability in tight spaces. Consequently, forklifts cannot always fit in the available space around packaging assembly lines. We describe an exemplary lifting device and a method for installing, moving, replacing, uninstalling, or otherwise transporting a dunnage conversion machine, particularly where the mounting location is elevated.

Accordingly, an exemplary lifting device includes a base frame for holding members fixed relative to each other, an upright support which is contiguous with an extendable support for additional stability, a lifting unit that provides enough power to raise and lower the dunnage conversion machine, and a machine interface bracket. The machine interface bracket is attached to the extendable supports, attachable to the dunnage conversion machine, and includes a face for the lifting unit to apply force to, to raise and lower the machine interface bracket and/or the dunnage conversion machine relative to an elevated mounting location.

The base frame may be provided with wheels to form a portable cart, handles to facilitate maneuvering the cart, and an interface for the lifting device. Preferably, the cart may be one already in use in the assembly line for transporting and supporting a supply of sheet stock material for the conversion machine. Additionally, the cart preferably has a smaller dimensional footprint than a forklift and would preferably have a better turn radius. This combination of the lifting device and mobile cart solves the problem presented by forklifts being too large to maneuver in tight spaces around packaging assembly lines.

An exemplary method for installing a dunnage conversion machine to an elevated mounting location in a packaging assembly line includes the following steps. The first step of the process is preparing a cart to be ready to receive the lifting device. An empty cart may be used or a cart with sheet stock material can be used after removal of the stock material. Once the cart is ready, the lifting device may be mounted to the cart. After the lifting device is mounted, an external power supply can be attached to power the lifting device and a forklift can be used to mount a dunnage conversion machine on the lifting device. The cart can then be maneuvered to the installation location, and the lifting device raises the dunnage conversion machine from a lower transport position to an elevated mounting position. The dunnage conversion machine can then be mounted and the lifting device can be disconnected and lowered. The lifting device can then be removed form the cart and the cart restocked with a supply of stock material for use by the dunnage conversion machine. A method of removing a dunnage conversion machine from the elevated position in the packaging assembly line works the same way, in reverse.

More particularly, the lifting device for supporting and lifting a dunnage conversion machine includes a base frame, an upright support that is fixed to the base frame, an extendable support that is adjustable between a lower position and a higher position, and a lifting unit coupled to the extendable support to raise and lower the extendable support between the lower position and the higher position.

The lifting device may include one or more of the following additional features. The base frame may be configured to be temporarily mounted to a portable cart to allow the cart to be used for other purposes when the lifting device is not in use. The upright support may include two members that add stability to each extendable support. The lifting device may include two extendable supports. The extendable supports may be coupled to the base frame symmetrically about its midpoint. The lifting unit may be positioned at the midpoint of the base frame. Preferably, when there are multiple extendable supports then the lifting unit is placed in such a way as to distribute forces evenly between the extendable supports.

Additional features of the lifting device may include one or more of a machine interface bracket, at least one forklift bracket, and an external power supply. The machine interface bracket may be attached to the lifting unit and the extendable supports. This can ensure that the extendable supports are moved in unison with the lifting unit. The machine interface bracket also can facilitate connecting the lifting device securely to a dunnage conversion machine. One or more forklift brackets may be secured to the dunnage conversion machine when it's not in use in an assembly line. The forklift brackets may have an interface for attaching to the dunnage conversion machine and are configured to be used in combination with a forklift when there is enough space for a forklift to maneuver.

The lifting device also may include or may be mounted to a cart having a horizontal support platform. Specifically, the base frame may be mounted to the horizontal support platform. In that case, the lifting device preferably is mounted within a footprint defined by the horizontal support platform.

The lifting unit may include a drive and a bar extending outwardly from the drive. The drive may be an hydraulic drive as an alternative to mechanical gears, an electric motor or another type of motor. The drive applies force through the bar on the bottom surface of the machine interface bracket. The bar is in contact with the machine interface bracket and the drive may be fixed to the base so that when the bar is moved by the drive, the machine interface bracket may move in unison. This motion is preferably linear. Finally, the lifting device may include an external power source.

An exemplary method for supporting and lifting a dunnage conversion machine typically includes the following steps. An operator prepares the dunnage conversion machine to interface with a lifting device. The operator adjusts the dunnage conversion machine from a position of operation to another position to interface with the lifting device. A hanging bracket may have at least one pivot point to allow this motion. An additional step of preparation may include removing a bracket from the bottom of the dunnage conversion machine. This can create a clear path for the lifting device to connect to the dunnage conversion machine. Next, if the lifting device is not already on a portable cart then the operator may temporarily attach the lifting device to a portable cart. Once the lifting device is secure then the cart may be positioned underneath a dunnage conversion machine. Next a power supply is provided for the lifting device. This can be achieved through an external power source in the form of a battery or wall outlet. The operator then raises the machine interface bracket up from a lower position to a higher position so that the machine interface bracket and the dunnage conversion machine are contiguous. Next, the lifting device is temporarily fixed to the dunnage conversion machine and released from the hanging bracket. Next the operator may lower the lifting device from the higher position to the lower position.

After the previous step is completed, the operator may choose to transport the dunnage conversion machine in different ways. The machine may be left on the lifting device and moved to a desired location. Alternatively, the operator may attach forklift brackets to the dunnage conversion machine. Once the cart has been moved into a location where a forklift has enough space to maneuver the dunnage conversion machine may be lifted off the lifting device and transported to a desired location.

When the dunnage conversion machine is ready to be stored it can be placed on a storage rack that is configured to mate with the brackets on the dunnage conversion machine.

The motive device may be controlled through a user interface.

### BRIEF DESCRIPTION OF THE DRAWINGS

FIG. 1 is a perspective view of packaging assembly lines with dunnage conversion machines mounted at an elevated position;

FIG. 2 is a perspective view of a portable cart;

FIG. 3 is a perspective view of the portable cart of FIG. 2 loaded with a supply of fan-folded sheet stock material for supplying a dunnage conversion machine, as shown in FIG. 1;

FIG. 4 is a perspective view of an exemplary lifting device on a pallet;

FIG. 5 is a perspective view of the lifting device of FIG. 4 mounted to the portable cart of FIG. 2 in a lower position;

FIG. 6 is a perspective view of the lifting device of FIG. 4 mounted to the portable cart of FIG. 2 in a higher position;

FIG. 7 is a perspective view of a dunnage conversion machine on a pallet.

FIG. 8 is a perspective view of the dunnage conversion machine of FIG. 7 mounted to the lifting device of FIG. 5 in the lower position; and

FIG. 9 is a perspective view of the dunnage conversion machine on the lifting device as shown in FIG. 8, with the lifting device in the higher position.

### DETAILED DESCRIPTION

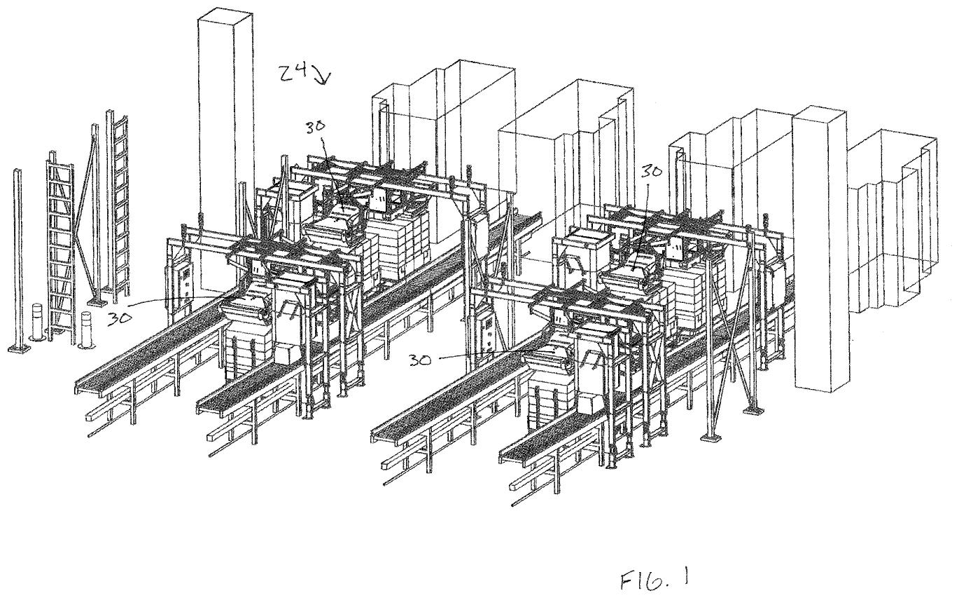

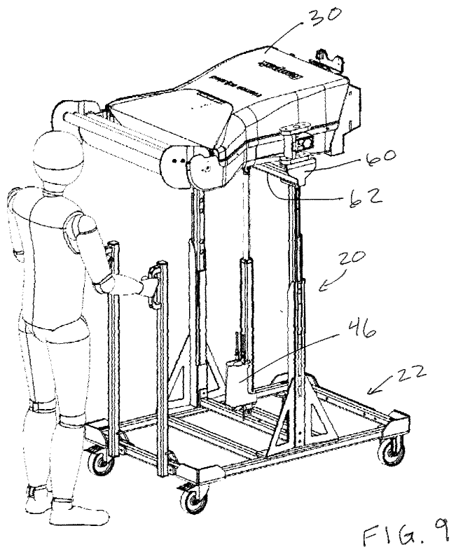

Referring now to the drawings, and initially to FIGS. 1 and 9, an exemplary lifting device 20 can be mounted to a mobile cart 22 with a relatively small footprint as compared to that of a forklift, to facilitate maneuvering in tight spaces around a packaging assembly line 24 to install or remove a dunnage conversion machine 30 in an elevated operating position.

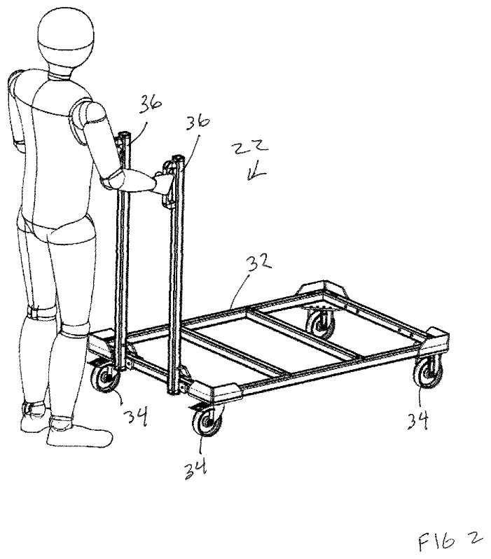

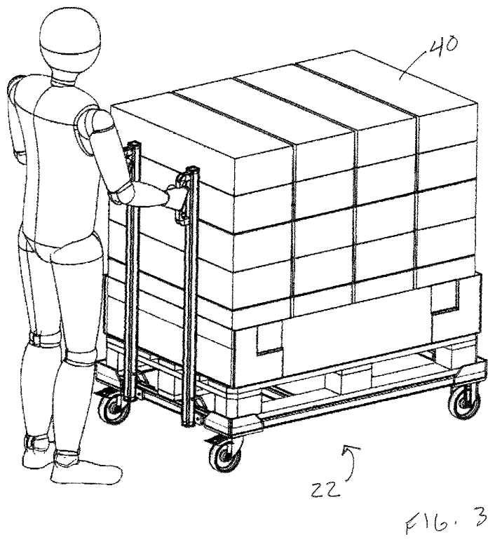

As shown in FIG. 2, an exemplary cart 22 has a horizontal support platform 32 mounted on wheels 34, with one or more handles 36 extending vertically upward at one end of the support platform 32 to facilitate maneuvering the cart 22. The dimensions of the cart 22 are such that the cart 22 is readily maneuverable in smaller spaces than a standard motorized forklift. When not being used with the lifting device 20, and as shown in FIGS. 1 and 3, the cart 22 can be used to supply rectangular stacks of fan-folded sheet stock material 40 to a dunnage conversion machine 30 in an elevated position on a packaging assembly line 24.

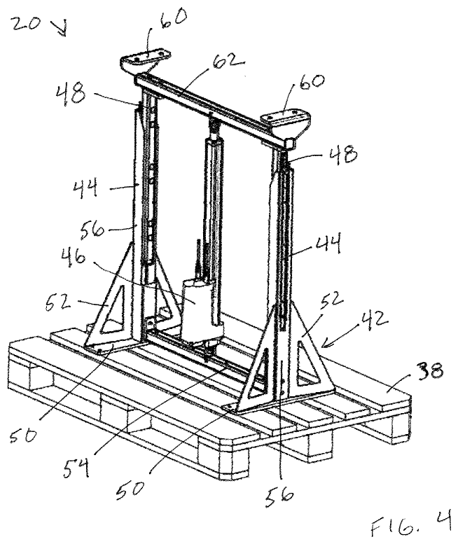

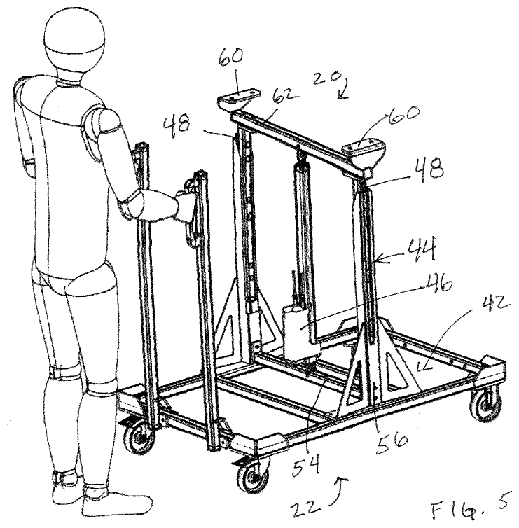

Turning to FIGS. 4 and 5, an exemplary lifting device 20 is shown mounted on a pallet 38 in FIG. 4 for storage or transport, and mounted on a cart 22 in FIG. 5. The lifting device 20 typically has a footprint that fits within the footprint of the horizontal support platform 32 of the cart 22. The connection between the lifting device 20 and the cart 22 may be temporary or permanent, but a temporary connection allows the cart 22 to be in continuous use for other purposes, such as as a supply of sheet stock material 40 (FIG. 3). The lifting device 20 includes a base frame 42, a pair of upright supports 44 that may be referred to as legs, and a motive device 46 for raising and lowering height-adjustable portions of the legs 44. The lifting device 42 typically will be centered on the support platform 32 on the cart 22, but may be offset to accommodate a dunnage conversion machine 30 (FIG. 9) with an off-center center of gravity. The lifting device 20 typically is mounted to the cart 22 such that a dunnage conversion machine 30 mounted to the lifting device 20 also would be contained within the footprint of the cart 22.

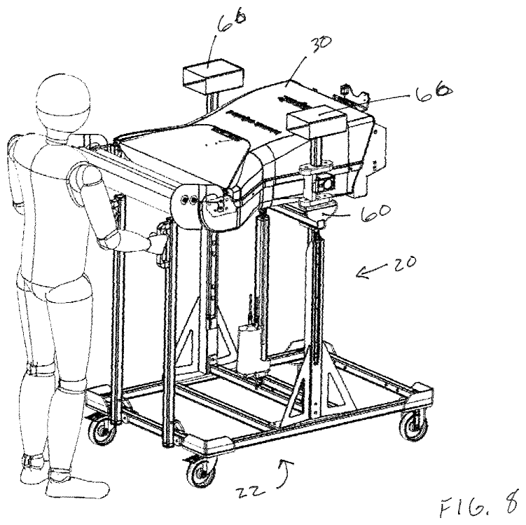

The base frame 42 provides an anchor point for securely holding the lifting device 20 to the cart 22 or other support surface (such as the pallet 38 (FIG. 4)) and providing stability for supporting and transporting a dunnage conversion machine 30 (FIG. 8). The lifting device 20 may be secured to the cart 22 in a variety of ways, including screws, nuts and bolts, pins and cooperating clips, a latch system similar to what is used on the backdoor of large trailers and moving trucks, or a groove for the lifting device to slide into, as just a few examples.

The illustrated base frame 42 includes a pair of spaced apart feet 50 that engage the support platform 32 of the cart 22, as shown in FIG. 1, or a pallet 38 for storage or transport, as shown in FIG. 3. The feet 50 also may include angled support members 52 that buttress the legs 44 and provide stability against forces transverse the legs 44. The base frame 42 also includes a base cross member 54 that connects the feet 50 and supports one end of the motive device 46.

The motive device 46 also can be referred to as a lifting unit, and may include a hydraulic element, electric motor, or other motive means sufficient to raise and lower height-adjustable portions 48 of the upright legs 44 and a dunnage conversion machine 30. To facilitate remote use the motive device 46 may include a portable power supply, such as a battery.

The upright legs 44 are substantially vertical (“substantially vertical” includes within about 10% of vertical) and extend upward from the feet 50. The upright legs 44 include a base portion 56 fixed to the feet 50 and a movable portion, also referred to as the height-adjustable portion 48, that is vertically movable relative to the base portion 56. The illustrated embodiment includes a pair of parallel, spaced-apart upright legs 44 attached to respective feet 50, and the height-adjustable portions 48 are telescopically and axially movable relative to the base portions 56. The base portions 56 are integrally formed with the feet 50 and cooperate with the feet 50 and the angled support members 52 to form right triangles. The height-adjustable portions 48 have a dominant length dimension, and the height-adjustable portions 48 are movable in an axial direction parallel to the length dimension.

A distal end of the height-adjustable portion 48 of each of the upright legs 44 includes a machine interface bracket 60 to which a dunnage conversion machine 30 (FIG. 8) may be temporarily secured. The illustrated lifting device 20 also includes a lifting cross member 62 extending between and connecting the distal ends of the height-adjustable portions 48 of the upright legs 44. The machine interface bracket 60 may be incorporated into the lifting cross member 62 instead of or in addition to the height-adjustable portions 48 of the upright legs 44. The machine interface brackets 60 that connect the dunnage conversion machine 30 to the lifting device 20 typically are configured to removably secure the dunnage conversion machine 20 to the machine interface brackets 60. Suitable connections may be provided by screws, nut and bolt fasteners, a pin locking system, a clamp system, a magnetic bracket system, an interlocking groove system, etc.

The motive device 46 is mounted to both the base cross member 54 and the lifting cross member 62 and can be controlled to extend and apply force to the lifting cross member 62 to move the lifting cross member 62 and the height-adjustable portions 48 of the upright legs 44, as well as a dunnage conversion machine 30 mounted to the machine interface brackets 60. The lifting cross member 62 is preferably made of a material and geometry that will not bend or flex under load to allow for accurate and consistent operation of the lifting device.

The movement of the height-adjustable portions 48 of the upright legs 44 are coupled together by the lifting cross member 62. In an alternative embodiment, the lifting unit 46, height-adjustable portions 48 of the upright legs 44, and the machine interface brackets 60 could be combined in a single unit. A single component could serve as a height-adjustable portion 48 of the legs 44, have a power source and a motor to serve as the lifting unit 46, and an end of the lifting unit 46 could be configured to attach to a dunnage conversion machine 30. The motion of the lifting unit 46 and the machine interface bracket 60 may be directly related, meaning the height-adjustable portions 48 of the upright legs 44 will extend the same distance the lifting unit 46 moves. Alternative devices, such as levers, gears, or fluid mechanics, could be used so that the motion of the height-adjustable portions 48 of the legs 44 is indirectly related to the motion of the lifting unit 46, meaning that motion of the lifting unit 46 is much greater or much less than the motion of the machine interface bracket 46.

In use, an operator typically will control the actuation of the lifting unit 46 through a user interface (not shown). The user interface could consist of a lever, a set of buttons, a dial or any device that would receive user input to signal the lifting unit to move. The user interface may be integrated with or mounted to the handles on the cart.

In the present embodiment, the lifting unit 46 is mounted between the two upright legs 44. Alternatively, more than one lifting unit, a different number of feet and upright legs, or the position of the lifting units and configuration of the feet and upright legs may be varied.

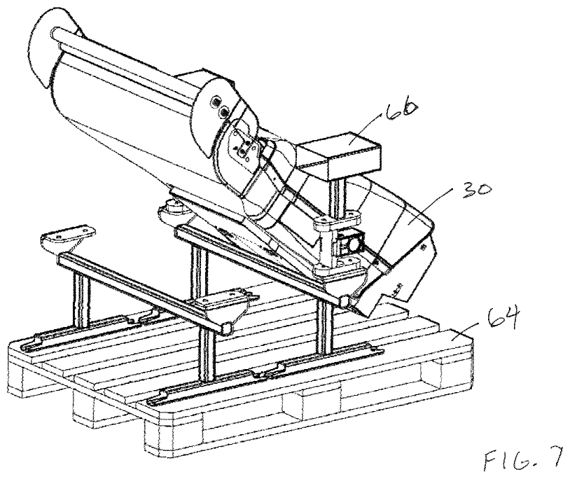

Referring now to FIG. 7, forklift brackets 66 may be attached to the machine interface brackets 60 on the lifting device 20 or to the dunnage conversion machine 30 to facilitate using forks of a forklift to lift the lifting device 20 to or from the cart 22 or to lift the dunnage conversion machine 30 to or from a mounting position on the lifting device 20. The dunnage conversion machine 30 mates with the forklift brackets 66 in the same way that the dunnage conversion machine 30 mates with elevated support structures in a packaging assembly line 24 (FIG. 1).

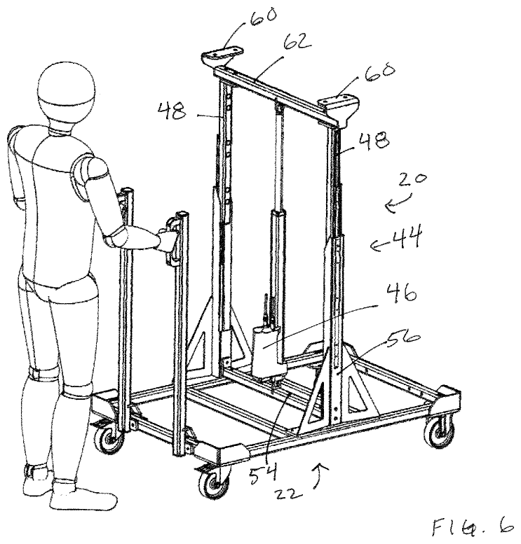

With the structure described, we turn now to a description of the operation of the lifting device 20 and the cart 22. The lifting device 20, and particularly the movable elements of the lifting device 20 (the height-adjustable portions 48 of the legs 44, the lifting cross member 62, the machine interface brackets 60, and the lifting unit 46), are movable between a lower position (FIG. 5) and a higher or upper position (FIG. 6). The lifting device 20 is shown in the lower position in FIG. 5. The lower position, with a lower center of gravity and more compact dimensions, allows for easier maneuvering and storage of the lifting device 20 with or without a dunnage conversion machine 30 mounted to the machine interface brackets 60.

The lifting device 20 is shown in the upper position in FIG. 6, where the height-adjustable portions 48 of the legs 44, the lifting cross member 62, and the machine interface brackets 60 are raised to a higher elevation relative to the base frame 42 in comparison to the lower position of FIG. 1. This higher elevation can be beneficial when the machine interface bracket 60 needs to be in contact with a dunnage conversion machine 30 at an elevated position for use in a packaging assembly line 24. In use, the lifting device 20 will be held in the lower position most of the time, and only raised to the upper position temporarily to raise or lower a dunnage conversion machine 30 to or from the elevated position. The lifting device 20 typically will be maintained at the upper position only for as long as it takes to transfer a dunnage conversion machine 20 between the machine interface brackets 60 and corresponding support structures at the location of use in the packaging assembly line 24 (FIG. 1).

An exemplary method for mounting, dismounting, and/or exchanging a dunnage conversion machine 30 used at an elevated location includes the following steps. Starting with a provided portable cart 22, such as a cart 22 that also can be used to provide a supply of sheet stock material 40 (FIG. 3), and clearing the support surface formed by the support platform 32 on the cart 22 to receive the lifting device 20. A provided lifting device 20, which may be stored remotely until needed, such as on the pallet 38 (FIG. 4), is positioned on the cart 22 and securely attached or otherwise mounted to the support platform 32 of the cart 22. The lifting device 20 may be permanently mounted or temporarily mounted to the cart 22. The lifting device 20 is thus ready for use in moving a dunnage conversion machine 30. The lifting device 20 can be mounted to the cart 22 for use and then removed, and the cart 22 can be returned to its prior use or put to another use.

The steps for moving and raising a dunnage conversion machine 30 to an elevated mounting position start with providing a dunnage conversion machine 30 and securing the machine 30 to the lifting device 20. Specifically, attaching the dunnage conversion machine 30 to the machine mounting brackets 60 and securing the machine 30 thereto. This step may include attaching forklift brackets 66 to the dunnage conversion machine 30 and using a forklift to lift and support the dunnage conversion machine 30 against the machine mounting brackets 60 for the attachment. The forklift brackets 66 may be removed when no longer needed. With the lifting device 20 in the lower position, the cart 22 is then maneuvered to a position underneath the elevated operating location for the dunnage conversion machine 30. If the lifting device 20 does not have a power supply, power is provided to the lifting unit 46, and the operator engages the lifting unit 46 to raise the dunnage conversion machine 30 to the elevated position at the packaging assembly line 24. The dunnage conversion machine 30 is then connected to the elevated support structure and disconnected from the lifting device 20. The lifting unit 46 is engaged again to move from the elevated position back to the lower position and removed from the packaging assembly line 24. The lifting device 46 can be removed from the cart 22 and stored, such as on a pallet 38, and the cart 22 can be returned to other service, such as loading a supply of fan-folded sheet stock material 40 onto the cart 22 and returning the cart 22 to a position underneath the dunnage conversion machine 30 at the packaging assembly line 24 (FIG. 1) to supply the sheet stock material to the dunnage conversion machine 30.

When the time comes to remove the dunnage conversion machine 30, the steps are reversed. The cart 22 is cleared, the lifting device 20 is mounted on the cart 22, and the cart 22 is moved to a location in the packaging assembly line 24 below the dunnage conversion machine 30. The lifting unit 46 is engaged to move to the elevated position, and the dunnage conversion machine 30 is attached to the machine mounting brackets 60 and disconnected from the elevated support structure. The lifting unit 46 is then engaged to lower the dunnage conversion machine 30 to the lower position and the cart 22 can be maneuvered away from the packaging assembly line 24. Once removed, forklift brackets 66 can be attached to the dunnage conversion machine 30 and a forklift can engage the forklift brackets 66 to support the dunnage conversion machine 30 while it is disconnected from the machine mounting brackets 60 on the lifting device 20. The forklift can then lift the dunnage conversion machine 30 off the lifting device 20 and transport the machine 30 to a desired location for transport or storage, such as on a pallet 64 configured to support a dunnage conversion machine 30 thereon for storage or transport, as shown in FIG. 7.

In summary, the present invention provides a lifting device 20 for supporting and lifting a dunnage conversion machine 30, and more particularly a lifting device 20 that can be mounted to a mobile cart 22 with a relatively small footprint that can be easily maneuvered in tight spaces around a packaging assembly line 24 to install or remove a dunnage conversion machine 30 in an elevated operating position. The lifting device 20 includes a base frame 42; a base portion 56 of an upright support 44 that is fixed relative to the base frame 42; an extendable support, also referred to as a movable, height-adjustable portion 48, that is adjustable between a lower position and a higher position, and a lifting unit coupled to the extendable support to raise and lower the extendable support 48 relative to the base frame 42 between the lower position and the higher position. The extendable support 48 is configured to be attached to the dunnage conversion machine 30 by a machine interface bracket 60.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A lifting device for supporting and lifting a dunnage conversion machine, the lifting device comprising:
a base frame;
an upright support having a base portion that is fixed relative to the base frame and a movable portion that is axially movable relative the base portion between a lower position and an upper position vertically higher than the lower position;
a lifting unit connected to the movable portion of the upright support to raise and lower the movable portion relative to the base frame between the lower position and the upper position;
wherein the upright support is configured to be attached to the dunnage conversion machine.

2. The lifting device as claimed in claim 1, wherein the base frame is configured to be removably mounted to a portable cart.

3. The lifting device as claimed in claim 1, wherein the base portion of the upright support is fixed to the base frame and the movable portion is telescopically movable relative to the base portion.

4. The lifting device as claimed in claim 1, wherein the base frame includes a pair of spaced apart feet with an upright support attached to each of the feet.

5. The lifting device as claimed in claim 1, wherein the upright support includes a pair of parallel, spaced apart upright supports.

6. The lifting device as claimed in claim 5, wherein the lifting unit is mounted to the base frame between the upright supports.

7. The lifting device as claimed in claim 5, wherein a distal end of each of the upright supports is connected by lifting cross member, and the lifting unit is coupled to the pair of upright supports by the lifting cross member.

8. The lifting device as claimed in claim 7, wherein lifting unit is mounted between the base frame and the lifting cross member.

9. The lifting device as claimed in claim 5, further comprising a machine interface bracket at a distal end of each of the upright supports, and the machine interface bracket has an interface for attaching to the dunnage conversion machine.

10. The lifting device as claimed in claim 1, further comprising one or more forklift brackets having have an interface for attaching to the dunnage conversion machine, wherein said one or more forklift brackets have an opening to receive a fork of a forklift.

11. The lifting device as claimed in claim 1, wherein the lifting unit is hydraulic.

12. The lifting device as claimed in claim 1, further comprising a cart having a horizontal support platform, and the base frame is mounted to the horizontal support platform.

13. The lifting device as claimed in claim 12, where the lifting device is mounted within a footprint defined by the horizontal support platform.

14. A method for supporting and lifting a dunnage conversion machine, comprising the steps of:
preparing the dunnage conversion machine to interface with a lifting device;
positioning the lifting device underneath a dunnage conversion machine;
connecting the dunnage conversion machine to a machine interface bracket of the lifting device;
raising the machine interface bracket from a lower position to an upper position; and
lowering the machine interface bracket from the upper position to the lower position.

15. The method as claimed in claim 14, wherein the preparing step includes mounting the lifting device to a movable cart.

16. The method as claimed in claim 14, comprising the step of moving the dunnage conversion machine to a preferred location by use of the movable cart.

17. The method as claimed in claim 14, wherein the connecting step occurs before the positioning step.

18. The method as claimed in claim 14, wherein the connecting step occurs before the raising step.

19. The method as claimed in claim 14, wherein the connecting step occurs before the lowering step.

20. The method as claimed in claim 14, wherein the preparing step includes connecting one or more forklift brackets to the dunnage conversion machine and moving the dunnage conversion machine using forks of a forklift to engage the forklift brackets.
